(19) United States
(12) Patent Application Publication
(10) Pub. No.: US 2014/0043129 A1
(43) Pub. Date: Feb. 13, 2014

(54) INDUCTOR ELEMENT AND MANUFACTURING METHOD THEREOF

(71) Applicant: SAMSUNG ELECTRO-MECHANICS CO., LTD., Gyeonggi-do (KR)

(72) Inventors: Sung Kwon WI, Gyeonggi-do (KR); Won Chul SIM, Gyeonggi-do (KR); Young Do KWEON, Gyeonggi-do (KR); Young Seuck YOO, Gyeonggi-do (KR)

(73) Assignee: SAMSUNG ELECTRO-MECHANICS CO., LTD., Gyeonggi-do (KR)

(21) Appl. No.: 13/830,489

(22) Filed: Mar. 14, 2013

(30) Foreign Application Priority Data
Aug. 9, 2012 (KR) 10-2012-0087034

(51) Int. Cl. H01F 27/29; H01F 41/10

(52) U.S. Cl. CPC H01F 27/29; H01F 41/10
USPC 336/192; 29/602.1; 29/607

(57) ABSTRACT

Disclosed herein are an inductor element and a manufacturing method thereof. The inductor element includes: an electrode body formed of insulating material and having an internal electrode having a coil shape disposed therein; and external terminals formed on a part of the electrode body and each connected with both ends of the internal electrode, wherein electrode body is formed and separated on a base substrate, whereby a size of the inductor element is reduced.

### CROSS REFERENCE(S) TO RELATED APPLICATIONS

This application claims the benefit under 35 U.S.C. Section 119 of Korean Patent Application Serial No. 10-2012-0087034 entitled “Inductor Element and Manufacturing Method Thereof” filed on Aug. 9, 2012, which is hereby incorporated by reference in its entirety into this application.

### BACKGROUND OF THE INVENTION

1. Technical Field

The present invention relates to an inductor element and a manufacturing method thereof, and more particularly, to a miniaturized inductor element and a manufacturing method thereof.

2. Description of the Related Art

An inductor, which is one of important passive elements forming an electronic circuit together with a resistor, a capacitor, has been used as a component removing noise or forming an LC resonance circuit.

The inductor is classified into a winding type inductor manufactured by winding or printing a coil around a ferrite core and forming an electrode at both ends thereof, a multi-layered inductor manufactured by printing and multi-layering an internal electrode on one surface of a magnetic sheet or a dielectric sheet, and a thin film type inductor manufactured by plating internal electrodes having a coil shape on a base substrate using a thin film process. Recently, as a demand for miniaturized and slimmed products is increased, a demand for a chip type inductor element such as a multi-layered inductor, a thin film type inductor has been largely increased.

A general multi-layered inductor has a structure in which the plurality of magnetic sheets and dielectric sheets on which the internal electrodes are printed are multi-layered, wherein the internal electrodes are sequentially connected through via electrodes formed by penetrating through each sheet to generally form the coil structure. Further, in the case of the thin film type inductor, almost all the processes include forming a magnetic film on a base substrate, forming a coil of one layer or two layers, and forming the magnetic film thereon again, thereby completing the thin film type inductor.

Even though the multi-layered inductor or the thin film type inductor has a thin chip type, it is difficult to implement a more miniaturized inductor element due to a limitation in a structure in which the plurality of sheets are multi-layered or need to be formed on the base substrate.

In connection with this, Korean Patent Laid-Open Publication No. 10-2004-0106985 (hereinafter, Related Art Document) discloses that the inductor element is miniaturized by deforming a shape of a wound enamel copper wire so as to make a thickness thereof thin.

However, as described in the related art document, it is difficult to implement a subminiature thin film type inductor element only by changing a shape of an internal coil and manufacturing processes different from the processes of the related art are required, which may lead to the increase in process complexity and manufacturing costs.

### RELATED ART DOCUMENT

### Patent Document

(Patent Document 1) Patent Document: Korean Patent Laid-Open

### SUMMARY OF THE INVENTION

An object of the present invention is to provide a manufacturing method of an inductor element by forming an electrode body on a base substrate and then, separating the electrode body from the base substrate and an inductor element completed based on the same.

According to an exemplary embodiment of the present invention, there is provided an inductor element, including: an electrode body formed of insulating material and having an internal electrode having a coil shape disposed therein; and external terminals formed on a part of the electrode body and each connected with both ends of the internal electrode, wherein the electrode body is formed and separated on a base substrate.

The internal electrode may be configured in plural and vertically disposed in the electrode body in a height direction.

The inductor element may have a base substrate disposed on a bottom portion thereof and may be a thin type, including an electrode body formed therein by a thin film process.

The inductor element may further include: a magnetic composite formed of a magnetic powder and a polymer and disposed on a top surface of the electrode body.

The external terminal may be bonded to a part of the top surface of the electrode body in a land grid array (LGA) type or to a side thereof and an end of the top surface thereof continued from the side thereof.

According to another exemplary embodiment of the present invention, there is provided a manufacturing method of an inductor element, including: (a) preparing a base substrate; (b) forming an electrode body having an internal electrode disposed therein on one surface of the base substrate; (c) plating external terminals connected to both ends of the internal electrode on a part of the electrode body; and (d) separating the electrode body from the base substrate.

The base substrate may include a base member supporting the electrode body and a bonding member bonding the electrode body to the base member.

The step (d) may be performed by any one of a physical method using a router and a chemical method of irradiating ultraviolet (UV) or applying heating.

The step (b) may include: (b1) applying an insulating layer on the base substrate; (b2) plating the internal electrode on the insulating layer; and (b3) applying the insulating layer to cover the internal electrode.

The internal electrode may be configured in plural by repeatedly performing the steps (b2) and (b3).

The step (b2) may use any one of an additive method, a subtractive method, and a semi-additive method.

The manufacturing method may further include: after the step (c), forming a magnetic composite on a top surface of the electrode body.

### BRIEF DESCRIPTION OF THE DRAWINGS

FIG. 1 is an appearance perspective view of an inductor element according to an exemplary embodiment of the present invention.

FIG. 2 is a cross-sectional view of the line I-I′ of FIG. 1.

FIGS. 3 to 8 are process flow charts sequentially showing a manufacturing method of an inductor element according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

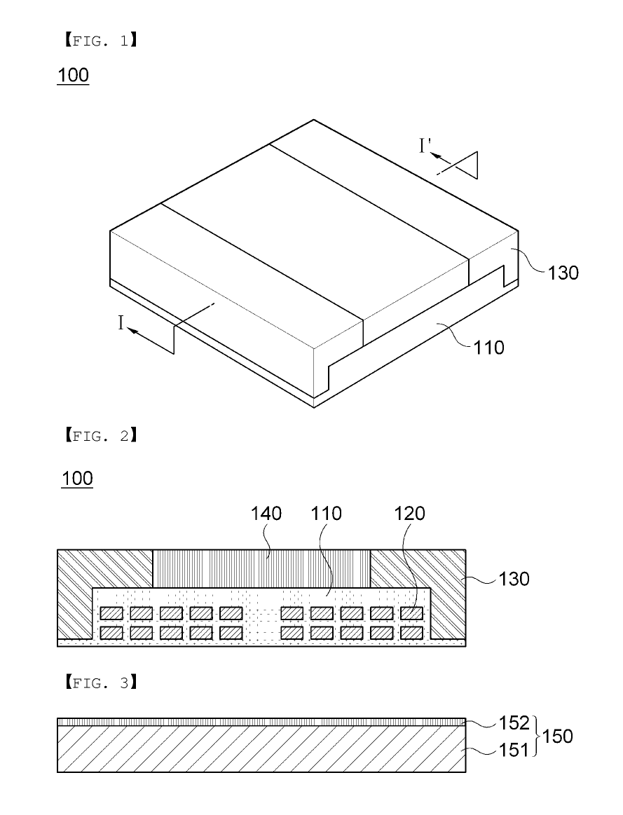

FIG. 1 is an appearance perspective view of an inductor element according to an exemplary embodiment of the present invention and FIG. 2 is a cross-sectional view of the line I-I′ of FIG. 1. In detail, components in the drawings are not necessarily drawn to the scale. For example, a size of a part of components in the drawing may be more exaggerated than other components so as to help the understanding of the present invention.

Referring to FIGS. 1 and 2, an inductor element 100 according to an exemplary embodiment of the present invention may include an electrode body 110 having an internal electrode 120 disposed therein and an external terminal 130 disposed on a part of the electrode body 110.

The electrode body 110 may be formed on a base substrate using the base substrate as a support member by a thin film process. Therefore, the inductor element 100 according to the embodiment of the present invention may be a thin film type.

In addition, a magnetic composite 140 may be provided on a top surface of the electrode body 110. The magnetic composite 140 is formed by mixing a magnetic powder with one of polyimide, epoxy resin, benzocyclobutene (BCB), or other polymer. Here, as an example of the magnetic powder, a magnetic material such as ferrite, Ni-based, Ni—Zn-based, Ni—Zn—Cu-based magnetic materials, and the like, may be used.

Reviewing in detail a material forming the electrode body 110, the electrode body 110 is formed of a non-magnetic insulating material including at least one of polyimide, epoxy resin, benzocyclobutene (BCB), and other polymers. Therefore, as shown in FIG. 1, the inductor element 100 according to the exemplary embodiment of the present invention has a shape in which a magnetic composite 140 having relatively higher permeability is disposed on the electrode body 110 having relatively lower permeability to implement high inductance capacity without hindering a main magnetic flux loop from being formed due to the internal electrode 120.

The external terminals 130 are each connected with both ends of the internal electrode 120 and therefore, is provided in pair. The external terminal 130 may be partially bonded to a top surface of the electrode body 110 in a land grid array (LGA) type or a side of the electrode body 110 and an end of the top surface thereof continued from the side thereof in an L type. In FIGS. 1 and 2, the L type of external terminal 130 is shown.

The internal electrode 120 patterned in a coil shape may be patterned by a thin film process such as thin film metal deposition, lithography, electroplating, and the like, and may include any one of silver (Ag), palladium (Pd), aluminum (Al), chromium (Cr), nickel (Ni), titanium (Ti), gold (Au), copper (Cu), and platinum (Pt) all of which have excellent conductivity.

In order to elucidate the subject matters of the present invention, although not shown in the drawings, one end of the internal electrode 120 is directly connected with an extracting electrode (not shown) that is formed by being exposed to a side portion of the electrode body 110 and the other end thereof is connected with another extracting electrode (not shown) through a via (not shown) and electrically connected with the external terminal 130 through the extracting electrodes.

The internal electrode 120 may be configured in plural so as to be vertically disposed in a height direction. In this case, one coil is formed by electrically each internal electrode 120 with each other through a via (not shown).

As described below, the electrode body 110 is formed by the thin film process while disposing the base substrate on the bottom and then, is separated from the base substrate when the external terminal 130 and the magnetic composite 140 are disposed on a part of the electrode body 110. Therefore, the inductor element 100 according to the exemplary embodiment of the present invention does not require the base substrate that is an essential component of the inductor element according to the related art. Accordingly, the size of the inductor element 100 is greatly reduced in a thickness direction and therefore, the inductor element 100 has a structure suitable for the miniaturization and slimness of products.

Hereinafter, a manufacturing method of the inductor element according to the exemplary embodiment of the present invention will be described.

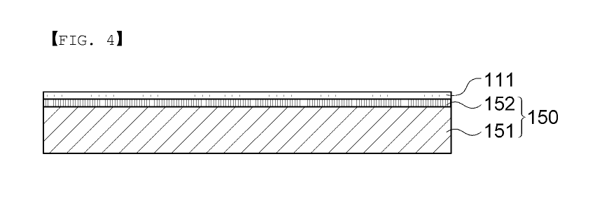

FIGS. 3 to 8 are process flow charts sequentially showing a manufacturing method of an inductor element according to the exemplary embodiment of the present invention.

The manufacturing method of the inductor element according to the exemplary embodiment of the present invention performs preparing a base substrate 150 as shown in FIG. 3.

Reviewing in more detail the structure of the base substrate 150, the base substrate 150 is configured to include a base member 151 supporting the electrode body 110 and a bonding member 152 that is bonded to one surface of the base member 151 to bond the electrode body 110 to the base member 151.

The base member 151 may support the electrode body 110 without warpage and therefore, needs to have a predetermined thickness according to a weight of the electrode body 110. Generally, the plurality of electrode bodies 110 needs to be produced by cutting a bar including the plurality of internal electrodes 120 along a predetermined cutting line so as to mass produce products. Therefore, the thickness of the base member 151 may be set in consideration of this.

Next, as shown in FIG. 4, an insulating layer 111 is applied on the base substrate 150. Here, the applied insulating layer 111 is a base layer of the electrode body 110. That is, when the electrode body 110 is separated from the base substrate 150 according to the subsequent process, the insulating layer 111 becomes the bottom in the completed inductor element. Therefore, the insulating layer 111 may preferably have a thickness enough to protect the internal electrode 120 from the external environment and support the internal electrode 120.

The insulating layer 111 may include at least one of polyimide, epoxy resin, benzocyclobutene (BCB), and other polymers and may be formed by methods such as deposition or solvent process, for example, spin coating, dip coating, doctor blading, screen printing, inkjet printing, thermal transfer, and the like, which are well-known to those skilled in the art.

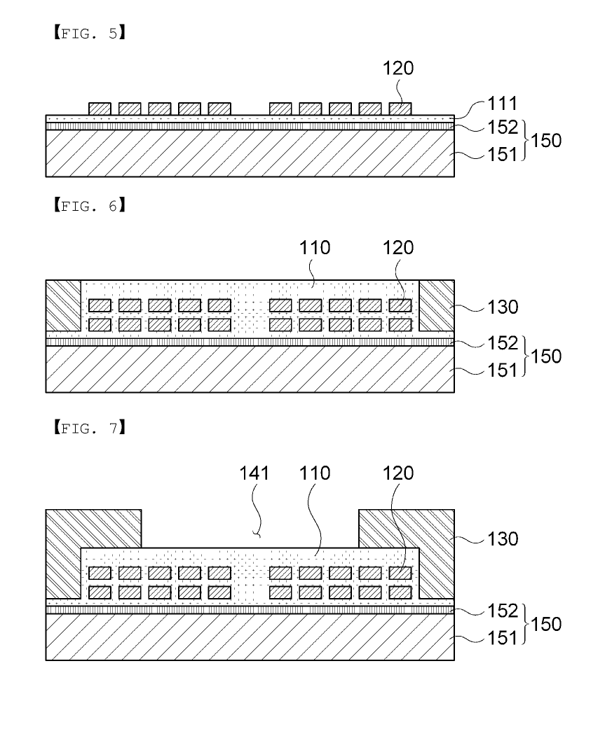

As such, when the insulating layer 111 is applied on the base substrate 150, as shown in FIG. 5, plating the internal electrode 120 having the coil shape on the insulating layer 111 is performed. In this case, it is preferable to perform the plating on the external terminal and the extracting electrode (not shown) together.

The plating process first forms a seed layer on the insulating layer by an electroless plating process or a sputtering process, bonds a dry film (D/F) thereto, and performs photo/developing/etching process to form a dry film pattern opposite to a coil pattern of the internal electrode 120. Next, the metal layer is formed by performing the electroplating using the seed layer as a lead line, the dry film is delaminated by etching, and the exposed seed layer is etched by performing flash etching, thereby forming the internal electrode 120 having the desired coil pattern. However, the exemplary embodiment of the present invention may form the internal electrode by an additive method, a subtractive method, and a semi-additive, and the like.

When the internal electrode 120 is formed, the insulating layer is applied so as to completely cover the internal electrode 120 and the internal electrode 120 configured to have a double layer structure by repeating the foregoing plating process again is formed on the insulating layer. In order to elucidate the present invention, the exemplary embodiment of the present invention forms only the internal electrode 120 having a double layer structure but may form the internal electrodes 120 more than above according to the required inductor capacity.

When the internal electrode 120 having the desired number of layers is formed, so as to implement the insulation property with the external terminal 130, the insulating layer is applied so as to cover the uppermost internal electrode 120 and then, the insulating layer built-up in the plurality of layers is pressed, thereby completing the electrode body 110 as shown in FIG. 6. In this case, the via hole (not shown) is patterned on the insulating layer covering the bottom internal electrode 120 and the inside of the via hole is plated at the time of the plating process to connect the internal electrodes of each layer with each other.

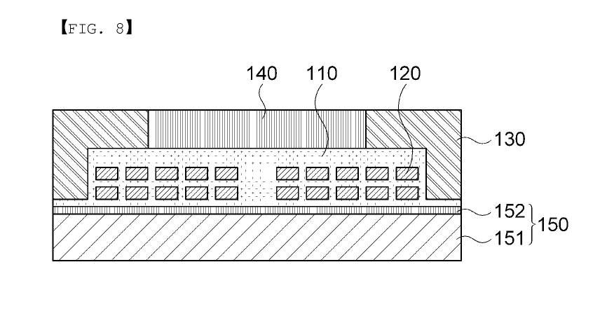

Next, as shown in FIG. 7, a process of plating a pair of external terminals 130 is performed on the end of the top surface of the electrode body 110.

Similarly to the internal electrode 120, the external terminal 130 may be generally formed by the additive method, the subtractive method, and the semi-additive method, and the like. At the time of plating the external terminal 130, the external terminal 130 is plated to have the same thickness as the magnetic composite 140 formed by the subsequent process.

Next, as shown in FIG. 8, a process of forming the magnetic composite 140 is performed on the top surface of the electrode body 110.

As shown in FIG. 7, when the pair of external terminals 130 are plated to the end of the top surface of the electrode body 110, a central portion of the top surface of the electrode body 110 is formed with an opening part (141 of FIG. 7) exposed to the outside due to the predetermined thickness of the electrode body 110. Here, when slurry prepared by pulverizing and mixing a magnetic powder, a binder, a plasticizer, and the like, by a ball mill is filled, the magnetic composite 140 may be prepared.

Meanwhile, the surface of the external terminal 130 buried due to the over filling of the slurry may be exposed to the outside and planarized by additionally performing a polishing process.

Finally, when the external terminal 130 and the magnetic composite 140 are provided in the electrode body 110, the process of separating the electrode body 110 from the base substrate 150 is performed to manufacture the finally completed inductor element of FIGS. 1 and 2.

The separating process peels off the bonding member 152 using a router as a physical method or adds a predetermined content of photoinitiator to the bonding member 152 as a chemical method and then, irradiates ultraviolet (UV) thereto to cure the bonding member 152, such that the adhesion can be lost. As another method, a foaming agent expanded by heat is added to the bonding member 152 and then, is heated to reduce a contact area between the bonding member 152 and the electrode body 110, such that the adhesion may also be lost.

Meanwhile, after the inductor element 100 is completed, in order to prevent the oxidation of the external terminal 130, improve the solderability, and the high conductivity, the nickel/gold plating layer may be additionally formed on the surface of the external terminal 130 exposed to the outside. The general electroplating method may be generally used or the electroless plating method, such as electroless nickel immersion gold (ENIG), electroless nickel autocatalytic gold (ENAG), electroless nickel electroless palladium immersion gold (ENEPIG) methods, and the like, may be used.

According to the manufacturing method of the inductor element according to the exemplary embodiment of the present invention, the inductor element can be manufactured without including the base substrate that is one of the essential components of the inductor element of the related art and therefore, the inductor element may be more easily manufactured, such that the productivity of the products and the saving of the manufacturing costs can be improved.

According to the inductor element and the manufacturing method thereof according to the exemplary embodiments of the present invention, it is possible to simplify the process and improve the productivity of products by removing several processes due to the presence of the base substrate, without the base substrate that is an essential component of the inductor element according to the related art.

Further, it is possible to cope with the miniaturization and slimness of products by reducing the overall size of the inductor element.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims include even another embodiment.

What is claimed is:

1. An inductor element, comprising:
an electrode body formed of insulating material and having an internal electrode having a coil shape disposed therein; and
external terminals formed on a part of the electrode body and each connected with both ends of the internal electrode,
wherein the electrode body is formed and separated on a base substrate.

2. The inductor element according to claim 1, wherein the internal electrode is configured in plural and vertically disposed in the electrode body in a height direction.

3. The inductor element according to claim 1, wherein the inductor element has a base substrate disposed on a bottom portion thereof and is a thin type, including an electrode body formed therein by a thin film process.

4. The inductor element according to claim 1, further comprising:
a magnetic composite formed of a magnetic powder and a polymer and disposed on a top surface of the electrode body.

5. The inductor element according to claim 1, wherein the external terminal is bonded to a part of the top surface of the electrode body in a land grid array (LGA) type or to a side thereof and an end of the top surface thereof continued from the side thereof.

6. A manufacturing method of an inductor element, comprising:
(a) preparing a base substrate;
(b) forming an electrode body having an internal electrode disposed therein on one surface of the base substrate;
(c) plating external terminals connected to both ends of the internal electrode on a part of the electrode body; and
(d) separating the electrode body from the base substrate.

7. The manufacturing method according to claim 6, wherein the base substrate includes a base member supporting the electrode body and a bonding member bonding the electrode body to the base member.

8. The manufacturing method according to claim 6, wherein the step (d) is performed by any one of a physical method using a router and a chemical method of irradiating ultraviolet (UV) or applying heating.

9. The manufacturing method according to claim 6, wherein the step (b) includes:
(b1) applying an insulating layer on the base substrate;
(b2) plating the internal electrode on the insulating layer; and
(b3) applying the insulating layer to cover the internal electrode.

10. The manufacturing method according to claim 9, wherein the internal electrode is configured in plural by repeatedly performing the steps (b2) and (b3).

11. The manufacturing method according to claim 9, wherein the step (b2) uses any one of an additive method, a subtractive method, and a semi-additive method.

12. The manufacturing method according to claim 6, further comprising:
after the step (c), forming a magnetic composite on a top surface of the electrode body.
